(19) United States
(12) Patent Application Publication
(10) Pub. No.: US 2017/0274468 A1
(43) Pub. Date: Sep. 28, 2017

(54) CONTACT CHIP FOR WELDING

(71) Applicant: SHINKOKIKI CO.LTD., Nagoya-Shi (JP)

(72) Inventor: Takeo FUKIZAWA, Nagoya-Shi (JP)

(73) Assignee: SHINKOKIKI CO.LTD., Nagoya-Shi (JP)

(21) Appl. No.: 15/592,546

(22) Filed: May 11, 2017

Related U.S. Application Data
(63) Continuation of application No. PCT/JP2015/080906, filed on Nov. 2, 2015.

(30) Foreign Application Priority Data
Dec. 25, 2014 (JP) 2014-267304

(51) Int. Cl. B23K 9/12

(52) U.S. Cl. CPC B23K 9/122

(57) ABSTRACT

A contact chip for welding, having a housing member with a tapered tip, an abrasion-resistant core member in the housing member, and an adapter member at the rear end of the housing member. The housing member has a first insertion hole as an outlet for a welding wire. The core member has a second insertion hole through which the welding wire is inserted. The adapter member has a third insertion hole through which the welding wire is inserted, and also has on the inner wall surface of its tip end part a taper surface whose diameter gradually decreases toward the tip end so that a space part is formed in the front of the core member. The welding wire is inserted through the first to third insertion holes and the space part so that the wire protrudes from the tip end of the contact chip.

### TECHNICAL FIELD

The present invention relates to a contact chip for welding, which guides a welding wire and supplies welding current.

### BACKGROUND ART

Conventionally, there are contact chips for welding which are configured so that a welding wire is inserted through an insertion hole 32 formed in a contact chip body 31 that is composed of a single body made of a copper alloy, as shown in FIG. 3, and is brought in contact with the wall surface of the insertion hole 32 to carry current for welding. In this case, however, there is a phenomenon that the copper alloy material softens due to micro discharge caused by the movement of a current carrying point because of the long insertion hole 32 and/or due to rise in temperature during welding. Further, there occurs a problem that, for example, upon repeated abrasion due to friction at the time of sending out the welding wire, the hole diameter of the tip end of the insertion hole 32 expands, thereby causing deterioration in quality such as defective appearance of welding beads. Therefore, it is necessary to periodically replace the contact chip for welding within a relatively short period of time.

Thus, there has been proposed a method for prolonging the replacement cycle for a contact chip for welding by subjecting the contact chip body to plating to improve the hardness. However, it is difficult to ensure a plating layer having a sufficient film thickness on the inside of the insertion hole similarly as on the outside thereof, because the insertion hole for the welding wire is narrow and long. Therefore, the method cannot be said to be a perfect countermeasure.

Further, in order to solve the aforementioned problems, there has been proposed a product wherein a ceramic body having excellent abrasion-resistance is fitted to the tip end of a contact chip body to prevent the abrasion of the tip end hole surface, as described, for example, in Patent Literature 1. The product described in Patent Literature 1, however, involves problems that dimensional changes occur due to thermal expansion at a high temperature during welding and that the ceramic body sometimes falls off due to the resistance of the frictional force applied to the ceramic body when the welding wire is sent out.

### CITATIONS LIST

### Patent Literature

Patent Literature 1: JP H10-193122 A

### SUMMARY OF INVENTION

### Technical Problems

The present invention has been made to solve the problems as mentioned above, and an object thereof is to provide a contact chip for welding, which ensures accurate welding while preventing the abrasion of an insertion hole for a welding wire and also ensures significant reduction in frequency of replacement of the contact chip without any change in tip end hole diameter of the insertion hole for the welding wire.

### Solutions to Problems

The contact chip for welding of the present invention, which has been made to solve the aforementioned problems, is a contact chip for welding, comprising a contact chip body, wherein

the contact chip body is composed of three members: a cylindrical housing member having a tapered tip end; an abrasion-resistant core member received in the housing member; and an adapter member mounted at the rear end of the housing member,

the housing member has formed at the center of its tip end a first insertion hole which serves as an outlet for a welding wire;

the core member has formed at its center a second insertion hole through which the welding wire is inserted;

the adapter member has formed at its center a third insertion hole through which the welding wire is inserted; further

the housing member has formed on the inner wall surface of its tip end part a taper surface whose diameter gradually decreases toward the tip end so that a space part is formed in the front of the core member; and

the welding wire is inserted through the third insertion hole of the adapter member, the second insertion hole of the core member, the space part, and the first insertion hole of the housing member so that the wire can be protruded from the tip end of the contact chip body.

According to a preferred embodiment, the core member is preferably selected from a plurality of core members made of different materials, and received in the housing member.

According to another preferred embodiment, the housing member is preferably selected from a plurality of housing members made of different materials.

### Advantageous Effects of Invention

The contact chip for welding of the present invention is configured so that the contact chip body is composed of three members, i.e., a cylindrical housing member having a tapered tip end, an abrasion-resistant core member received in the housing member, and an adapter member mounted at the rear end of the housing member; that the housing member has formed at the center of its tip end a first insertion hole which serves as an outlet for a welding wire; that the core member has formed at its center a second insertion hole through which the welding wire is inserted; that the adapter member has formed at its center a third insertion hole through which the welding wire is inserted; further that the housing member has formed on the inner wall surface of its tip end part a taper surface whose diameter gradually decreases toward the tip end so that a space part is formed in the front of the core member; and that the welding wire is inserted through the third insertion hole of the adapter member, the second insertion hole of the core member, the space part, and the first insertion hole of the housing member so that the wire can be protruded from the tip end of the contact chip body. Therefore, the lifetime of the contact chip for welding is significantly prolonged, and there is no risk that the core member would fall off

In the invention as defined in claim 2, the core member is selected from a plurality of core members made of different materials, and received in the housing member. So, the lifetime of the contact chip for welding is further prolonged, and a contact chip for welding having performance adapted for the welding conditions can be prepared.

In the invention as defined in claim 3, the housing member is selected from a plurality of housing members made of different materials. So, the lifetime of the contact chip for welding is further prolonged, and a contact chip for welding having performance that is adapted for the welding conditions can be prepared.

### BRIEF DESCRIPTION OF DRAWINGS

FIG. 1 is a cross sectional view showing an embodiment of the present invention.

FIG. 2 is an exploded view of a contact chip body in the embodiment of the present invention.

FIG. 3 is a cross sectional view showing a conventional contact chip for welding.

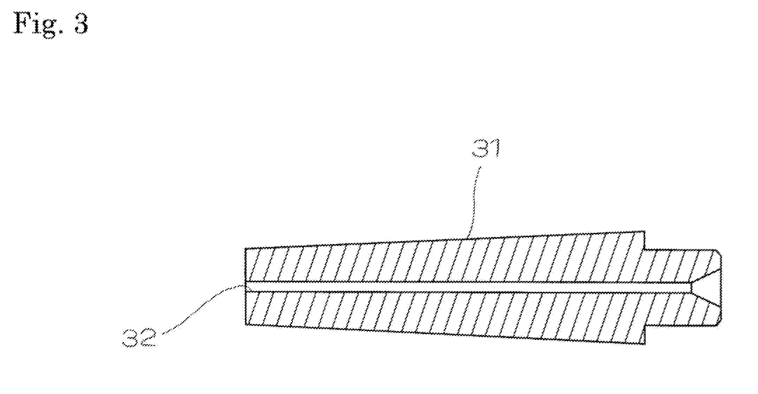

### DESCRIPTION OF EMBODIMENTS

Hereinafter, a preferred embodiment of the present invention will be illustrated with reference to the drawings.

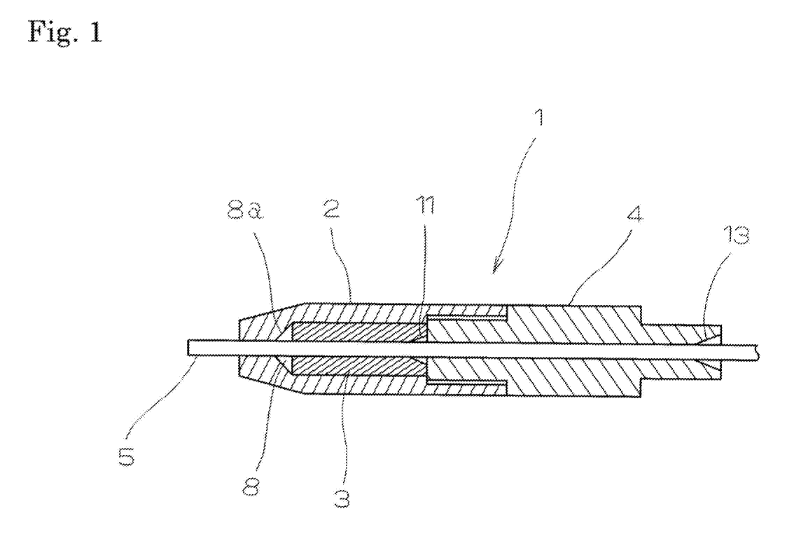

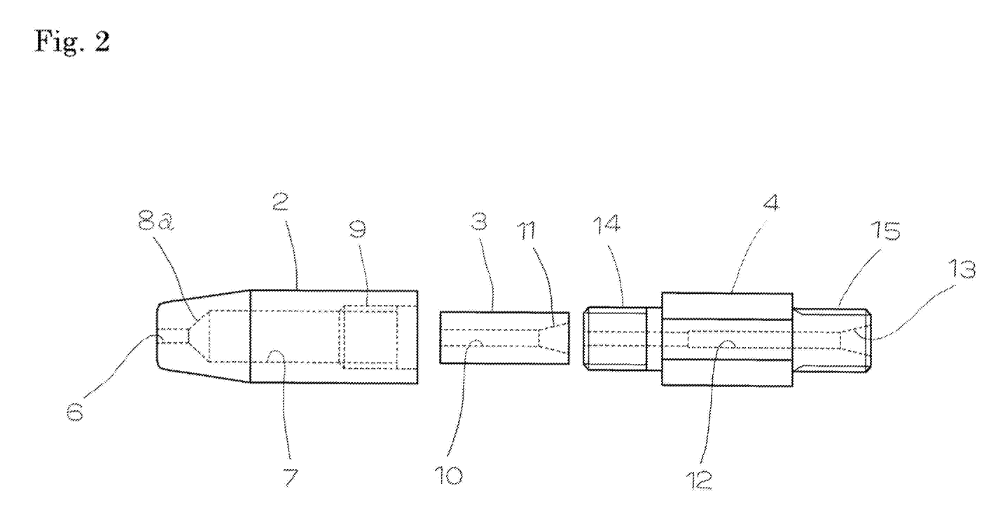

FIG. 1 is a cross sectional view showing a contact chip for welding of the present invention, and FIG. 2 is an exploded view thereof. In these figures, reference sign 1 designates a contact chip body made of a copper alloy. This contact chip 1 is composed of three members: a cylindrical housing member 2 having a tapered tip end; an abrasion-resistant core member 3 received in this housing member 2; and an adapter member 4 made of a copper alloy and attachably/detachably mounted at the rear end of the housing member 2 by screw joining.

The housing member 2 has formed in the central direction in its tip end part a first insertion hole 6 which serves as an outlet for a welding wire 5; has formed in its intermediate part a receiving part 7 which receives the core member 3 therein; and has formed in the rear part of the receiving part 7 a screw hole 9 for coupling the adapter member 4, and the core member 3 is configured to he inserted from the side of the screw hole 9 as an opening part and to be received in the receiving part 7.

Also, a taper surface 8a whose diameter gradually decreases toward the tip end is formed on the inner wall surface of the tip end part of the housing member 2. Thus, when the core member 3 is received in the receiving part 7, the tip end part of the core member 3, when brought in contact with the base part of the taper surface 8a, is fixed at that position, and cannot advance toward the front side any more. A space part 8 is formed in the front of the core member 3.

The core member 3 has insulating properties, for example, like ceramic, and is made of a material having excellent abrasion-resistance. A second insertion hole 10 through which the welding wire 5 is inserted is formed in the center axis direction, and a tapered guide part 11 which guides the welding wire 5 is provided at the rear end of this second insertion hole 10 and configured so that the welding wire 5 is smoothly guided into the second insertion hole 10.

Also, the adapter member 4 is intended to fix the core member 3 in the receiving part 7 of the housing member 2, and is made, for example, of a copper alloy. A third insertion hole 12 through which the welding wire 5 is inserted is formed in the center axis direction of the adapter member 4, and a tapered guide part 13 which guides the welding wire 5 is provided at the rear end of the third insertion hole 12. Also, a screw part 14 which is screwed into the screw hole 9 of the housing member 2 is formed at the tip end of the adapter member 4, and a screw part 15 which is screwed into a torch body (not shown) is formed at the rear end thereof.

In the thus-configured contact chip for welding of the present invention, the core member 3 is inserted from the rear part of the housing member 2 and received in the receiving part 7, and the adapter member 4 is attachably/detachably mounted by screwing the screw part 14 positioned at its tip end into the screw hole 9 positioned in the rear part of the housing member 2. In this case, the core member 3 is pushed into the housing member 2 until the tip end is brought in contact with the base part of the taper surface 8a, and thus is always set firmly at a predetermined position.

Thereafter, the welding wire 5 is inserted through the third insertion hole 12 of the adapter member 4, the second insertion hole 10 of the core member 3, the space part 8 of the housing member 2, and the first insertion hole 6 of the housing member 2, sent out of the contact chip body 1, and subjected to arc welding.

In the present invention, the contact chip body is composed of three members, i.e., the housing member 2, the core member 3 and the adapter member 4, thereby preventing the abrasion of the wire outlet hole at the tip end and surely preventing the falling-off of the core member 3. Also, the tapered part 8a whose diameter gradually decreases toward the tip end is formed on the inner wall surface of the tip end part of the housing member 2 so that the space part 8 is formed in the front of the core member 3. So, the air in this space part 8 would function as an electrically insulating material and a thermally insulating material. As a result, the short first insertion hole 6 of the housing member 2 stably works as a current carrying point, whereby the lifetime of the contact chip for welding is significantly prolonged. Further, there is an advantage that the first insertion hole 6 of the housing member 2 has a small diameter but is short, and thus can easily ensure the quality of the plating film thickness, for example, when plating is applied to the contact chip body 1.

The housing member 2 can improve the hardness by application of plating, and can also alleviate the deposition of sputter through the use of the releasability of plating. Also, when a copper alloy having low electric resistivity, such as tough pitch copper, is used as the copper alloy, the welding current value can be stabilized.

The material for the housing member 2 can arbitrarily be selected from a plurality of housing members made of different materials such as a plated chromium copper alloy, a surface-hardened chromium copper alloy, a zirconium chromium copper alloy, a beryllium copper alloy and stainless, according to the intended use.

The material for the core member 3 can arbitrarily be selected from a plurality of core members made of different materials such as stainless, a chromium copper alloy, a zirconium chromium copper alloy and alumina ceramic, all having excellent abrasion-resistance, according to the intended use.

For example, the use of stainless (SUS304) brings a state of heat generation and heat storage because of great electric resistivity and poor thermal conductivity of the core member 3, so that the effects of reducing the welding current and increasing the bead width are obtained by the hot wire effect due to heat supply to the welding wire 5. Also, the use of insulator ceramic results in concentrated current supply to the welding wire 5 from the first insertion hole 6 positioned in the tip end part, and thus provides the advantageous effects of a stable current supply point and a prolonged lifetime.

It is noted that the tip end of the housing member 2 is formed in a tapered shape, and thus there is no risk that the core member 3 would fall off.

According to the present invention, the contact chip body is composed of three members, i.e., a housing member, a core member and an adapter member, and a space part is provided between the first insertion hole positioned at the tip end of the housing member and the core member, as described above. So, this air layer functions as an electrically insulating material and a thermally insulating material; the first insertion hole stably works as the welding current carrying point; and thus the lifetime of the contact chip for welding can significantly be prolonged. Besides, there is no risk that the core member would fall off, whereby welding can be performed stably. Further, a contact chip for welding, which is suitable for solving the problems in welding, can be prepared by changing the respective members, and thus the performance of the contact chip for wielding can further be improved.

### REFERENCE SIGNS LIST

1. Contact chip body
2. Housing member
3. Core member
4. Adapter member
5. Welding wire
6. First insertion hole
7. Housing part
8. Space part
8a. Taper surface
9. Screw hole
10. Second insertion hole
11. Guide part
12. Third insertion hole
13. Guide part
14. Screw part
15. Screw part

1. A contact chip for welding, comprising a contact chip body, wherein
the contact chip body is composed of three members: a cylindrical housing member having a tapered tip end; an abrasion-resistant core member received in the housing member; and an adapter member mounted at the rear end of the housing member,
the housing member has formed at the center of its tip end a first insertion hole which serves as an outlet for a welding wire;
the core member has formed at its center a second insertion hole through which the welding wire is inserted;
the adapter member has formed at its center a third insertion hole through which the welding wire is inserted; further
the housing member has formed on the inner wall surface of its tip end part a taper surface whose diameter gradually decreases toward the tip end so that a space part is formed in the front of the core member; and
the welding wire is inserted through the third insertion hole of the adapter member, the second insertion hole of the core member, the space part, and the first insertion hole of the housing member so that the wire can be protruded from the tip end of the contact chip body.

2. The contact chip for welding according to claim 1, wherein the core member is selected from a plurality of core members made of different materials, and received in the housing member.

3. The contact chip for welding according to claim 1, wherein the housing member is selected from a plurality of housing members made of different materials.

4. The contact chip for welding according to claim 2, wherein the housing member is selected from a plurality of housing members made of different materials.
